(19) United States
(12) Patent Application Publication
(10) Pub. No.: US 2008/0011144 A1
(43) Pub. Date: Jan. 17, 2008

(54) SAW CHAIN HAVING MULTIPLE DRIVE LINK CONFIGURATIONS

(75) Inventors: Michael D. Harfst, Milwaukie, OR (US); Mark D. Lamey, Happy Valley, OR (US); Mike Goettel, Canby, OR (US); Lewis Scott, Lake Oswego, OR (US); Kent Huntington, Molalla, OR (US); Mike Patterson, Vancouver, WA (US); Todd Gerlach, Tualatin, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Blount, Inc., a limited liability company of Delaware, Milwaukie, OR (US)

(21) Appl. No.: 11/776,482

(22) Filed: Jul. 11, 2007

Related U.S. Application Data
(60) Provisional application No. 60/807,322, filed on Jul. 13, 2006.

(51) Int. Cl. B27B 33/14

(52) U.S. Cl. 83/830; 29/428; 83/169

(57) ABSTRACT

Embodiments of the disclosure provide a saw chain having cutter links having a cutting edge on a first end and an opposite second end adapted for riding on or along a rail of a guide bar. First drive links are coupled with the cutter links and are adapted to ride in a groove of a guide bar. The first drive links have a clean out tang sized and shaped to scoop debris from within the groove, and have two first drive link side surfaces on opposite sides thereof adapted to have at least occasional wearing contact with interior side walls of the groove. Second drive links are coupled with the first drive links and the cutter links, and are adapted to ride in the groove of the guide bar. Each second drive link has second drive link side surfaces adapted to have at least occasional wearing contact with the interior side walls of the groove. The second drive link side surfaces have a greater surface area than the first drive link side surfaces, and in some embodiments may be featured rudder links.

### RELATED APPLICATIONS

This application claims the benefit of U.S. Provisional application No. 60/807,322 filed on Jul. 13, 2006, entitled “SAW CHAIN HAVING MULTIPLE DRIVE LINK CONFIGURATIONS,” the entire disclosure of which is hereby incorporated by reference in its entirety.

### TECHNICAL FIELD

The present invention relates to the field of saw chains, and in particular to a saw chain having more than one type of drive link each adapted to do at least one of, provide stability within the bar groove and clean debris from the bar groove. Further, the drive link adapted to provide stability may be further adapted to manipulate the debris in the bar groove to help prevent buildup of debris and to promote removal of debris by the drive links adapted to clean.

### BACKGROUND

Chain saws include an endless saw chain loop disposed to articulate around a saw bar. The saw chains typically include drive links which ride within a bar groove on the guide bar. Debris formed when cutting some material, such as concrete, may not be prone to accumulate, and/or to accrete within the bar groove. Saw chain for concrete cutting chain saws may then include drive links which may be referred to as rudder links, and which may be generally uniformly curved from one side to the other side of the drive link. However, debris formed when cutting other material, such as wood, may tend to accumulate, and even accrete within the bar groove. The bottom of a rudder link may act as an iron, and press and solidify the debris into the groove. In order to remove such debris, drive links have been designed with a cutout portion forming a drive link tang or clean out tang. However, forming the clean out tang reduces the amount of material disposed in the area of the chain where it is needed for stability, i.e. the tip area of the drive link. Over time, with wear, the drive link becomes thin and is prone to fit loosely within the bar groove, and may tend to lean within the bar grove. As the saw chain leans excessively it may cause groove irregularities, can result in a binding of the chain, non-straight cuts kick back, and/or inhibit cutting altogether.

### BRIEF DESCRIPTION OF THE DRAWINGS

FIG. 1 is a side view illustrating a portion of a saw chain, in accordance with various embodiments of the invention;

FIG. 2 illustrates a side view illustrating a rudder link in accordance with various embodiments of the invention;

FIG. 3 illustrates a side view of a rudder link having a through hole in accordance with various embodiments the invention;

FIG. 4 is a perspective view of a rudder link having a slot therein in accordance with various embodiments the invention;

FIG. 5 is a side view of a rudder link having a slot therein with non-parallel top and bottom edges in accordance with various embodiments of the invention;

FIG. 6 is a side view of a rudder link having a relieved portion in accordance with various embodiments of the invention;

FIG. 7 is a side view of a rudder link illustrating multiple features such as those described in FIGS. 3, 4 and 6 be combined on a rudder link to form another embodiment;

FIG. 8 is a side view of a rudder link having an arcuate groove and a through hole in accordance with various embodiments of the invention;

FIG. 9 is a side view illustrating various embodiments having a point contact that may serve to break up debris within a groove of a guide bar;

FIG. 10 is a side view illustrating various embodiments wherein a rudder link includes a point contact substantially near a leading edge thereof;

FIG. 11 illustrates a side view of a rudder link coupled with a clean out drive link via tie straps in accordance with various embodiments of the invention;

FIGS. 12 and 13 illustrate side views of rudder links in accordance with various embodiments;

FIG. 14A is a side view and FIG. 14B is a sectional view taken through the line 14B-14B illustrating a rudder link in accordance with various embodiments of the invention;

FIGS. 15 and 16 are side views illustrating rudder links each having a serrated bottom edge in accordance with various embodiments;

FIGS. 17 and 18 illustrate rudder links in accordance with various embodiments of the invention having leading a trailing edge notches in accordance with various embodiments;

FIG. 19A is a side view and FIG. 19B is a sectional view taken of the line 19B-19B in FIG. 19A in accordance with various embodiments;

FIG. 20 is a side view of an embodiment illustrating a rudder link in accordance with various embodiments; and

FIG. 21 is a side view of a section of a saw chain disposed within a bar groove of a guide bar.

### DESCRIPTION OF THE PREFERRED EMBODIMENTS

In the following detailed description, reference is made to the accompanying drawings which form a part hereof, and in which are shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other. For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention may use a first predetermined percentage of rudder drive links to provide more chain material inside the bar groove for better wear and to resist leaning, and a second predetermined percentage of clean out drive links to help keep debris out of the groove.

Various embodiments may use an optimal ratio of clean out drive links to rudder drive links, for example, 2:1, wherein the stability drive links are approximately 33% of the total drive links. Still other embodiments may include featured rudder links having features that may help prevent the buildup of debris, and/or facilitate removal of the debris by the clean out drive links such that more than 33% rudder links may be used. In various embodiments, the ratio of clean out drive links to featured rudder drive links may approach, equal or exceed 1:1.

Such features that may discourage debris buildup and/or to facilitate removal of debris by the clean out drive links may be referred to as debris management features, and may include, but may not be limited to, one or more lubricating fluid distribution features; one or more surface tension breaking features; and/or one or more debris redistribution features. In some embodiments one or various combinations of these debris management features may be included on any particular featured rudder link.

Various embodiments may use 100% rudder links. In these embodiments the rudder links may include debris management features that may be sufficiently effective to discourage build-up of substantially any debris and/or to remove substantially all debris from within the bar groove.

Various embodiments may use more than one type of rudder link. Including various combinations of clean out links and rudder links of multiple types. Various embodiments may use 100% rudder links include one, two or more rudder link types.

Embodiments of the present invention pertain to using multiple drive link configurations in order to help enhance a balance between performance and durability for saw chain drive links, which is directly contrary to the conventional wisdom of using homogeneous parts for such applications.

In certain embodiments, the rudder link may have more wear surface at the highest wear area of the lower chassis. A typical example may be a ⅜ professional chain, which may have 60% more surface area on the side of the drive link, in the critical area corresponding to the area below the top of the clean out notch, verses a similarly sized drive link having a clean out notch.

Chain made according to various embodiments may have a rudder link that has less leaning in the bar groove than a clean out drive link at a later point in life, i.e., with considerable wear. Less leaning may avoid bar and chain hang-up in the cut and other undesirable results, such as improving end of life cutting performance. Embodiments according to the invention may provide greater stability, and improved performance when cutting. This may make the chain saw easier to handle and safer. Various embodiments according to the invention may also provide a saw bar that may experience longer life because the bar groove may be able to experience more wear before chain leaning becomes a performance issue, or a hang-up issue.

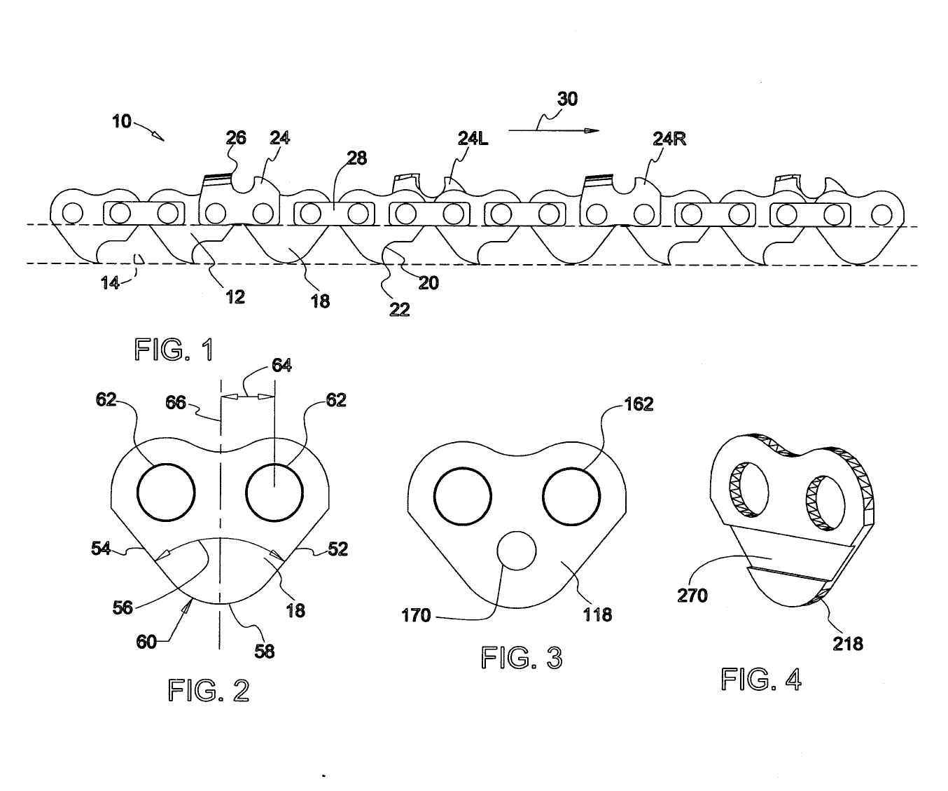

FIG. 1 is a side view illustrating a portion of a saw chain, and an example embodiment in accordance with the invention. A saw chain 10 may include a first drive link 12 adapted to ride in, and adapted to clear debris from, a bar groove 14 of a guide bar (illustrated only partially). A second drive link 18 may also be adapted to ride in the bar groove 14 and may be adapted to wear more slowly than the first drive link 12. The first drive link 12 may be referred to as a clean out link 12, and may be adapted to have a clean out notch 20 and a clean out tang 22. The second drive link 18 may be referred to as a rudder link 18 or a stability link, and may wear more slowly due to greater material and greater contact surface area with the inside walls of the guide bar as compared with that of the clean out link 12.

Cutter links 24 having cutting edges 26 may be coupled with the clean out links 12 and the rudder links 18 via tie straps 28. Arrow 30 indicates a direction of travel of the saw chain. As illustrated in FIG. 1, various embodiments may include two clean out drive links 12 for every two rudder links 18. The section of saw chain 10 also illustrates right hand 24R and left hand 24L cutter links interlinked to the drive links via drive links 12, 18 themselves and via tie straps 28.

Various embodiments may use rudder links 18 in an alternating sequence with the clean out links 12 and may thus provide the dual function of drive links with clean out tangs and drive links, or rudder drive links, with a full shape for better wear resistance, and/or better stability. Various embodiments may include a rudder link 18 before the cutter link 26. Various other embodiments may include the rudder link 18 after the cutter link 26. In various embodiments, it has been found that a 2:1 ratio of clean out links to rudder links may provide a good balance of stability and debris management.

Various cutting operations may have various clean out requirements and/or stability requirements based on, for example, the type of material being cut, or the size and consistency of the debris created. Applications requiring greater bar groove cleaning may have fewer rudder links 18 than clean out links 12, i.e., a less than a 50% ratio. Various other embodiments may include a higher percentage of rudder links, for example, a skip chain may include 67% rudder links.

The location of the rudder links may affect the function of the chain's performance under some circumstances. As mentioned, rudder links may be located at the fore or aft position with respect to the cutter to enhance bias cutting. For example, skip, and semi-skip, sequence chains can have rudder links located at the two fore positions. Some embodiments may provide other combinations. Specific sequences may be based upon test results indicating measurable enhancement or based on user perception of the “feel” of the chain. The frequency of the rudder links is not limited to, as mentioned, a 33%, 50% or 67% level. Various embodiments may use a minimum of either link type, for example, just one clean out link in the loop. Practical results may indicate the lower limit should be around four or five standard clean out tangs in a loop for some embodiments. Likewise the benefits of the rudder links may be maximized with the maximum number of rudder links but any number of rudder links, down to the theoretical limit of one, may provide benefits in accordance with the invention.

FIG. 2 illustrates a side view illustrating an embodiment in accordance with the invention. A rudder link 18 may include a substantially symmetrical profile including a leading edge 52 and a trailing edge 54 forming an angle 56. In various embodiments the angle 56 may substantially approach a right angle. In one embodiment the angle 56 may be about 80°. The leading edge 52 and the trailing edge 54 may meet at a filleted corner forming a rounded tip 58. The tip 58 may be substantially centered between two rivet holes 62. In various embodiments a fillet radius 60 may be substantially equal to a distance 64 from the center of one rivet hole 62 to a center line 66 of the rudder link 18. Various other embodiments may include nonsymmetrical rudder links to enhance the wear characteristics of the link. Likewise, various embodiments may include rudder links with different face angles.

The rudder links 18 may also have a better fit-up with the gullet of the nose sprocket. This may provide longer sprocket nose life. The greater amount of material near the tip 58 may provide better resistance to damage from the drive sprocket in the event of a chain jumping off the sprocket. The saw chain may also experience better entry flow onto the bar from the drive sprocket which in turn may translate to a longer bar life since the tail may not get peened and/or damaged as fast.

Symmetrically shaped drive links may be used with reversible saw chains. In addition, the shape of the rudder link may be contoured to maximize the fit-up with the sprockets that utilize various known sprocket designs. Other, chain saw components, such as a nose sprocket or drive sprocket, may have a shape corresponding to the rudder links. The rudder links, may work to keep the chain stable in the bar groove by providing the maximum amount of wear material at the high wear area of the chassis.

Various embodiments may include material treatment of one or both of the rudder links and the cleanout links to modify their strength, hardness and/or ductility at desired locations. For example the rudder link may be surface hardened to improve its wear resistance while the clean out link may be treated, or left untreated to ensure the tang has sufficient strength. Certain embodiments may be coated with various known materials to increase the wear resistance of the rudder link, or clean out link or both.

FIG. 3 illustrates a side view of a featured rudder link 118 having a lubricating fluid distribution feature 170 in the form of a through hole disposed below the rivet holes 162. The lubricating fluid distribution feature 170 may promote movement of a lubricating fluid, from one side of the link to the other, as well as towards the bottom of the groove. Applicant has found that directing fluid to the lower portions of the groove may result in debris within the groove to be less likely to adhere to the bottom of, or the sides of the grooves and the debris particles may be less likely adhere to one another. In various embodiments the lubricating fluid, and in particular the enhanced flow of the lubricating fluid due to the lubricating fluid distribution feature 170 may cause the debris within the groove to be more slurry-like. This not only may allow one or more clean out drive links (not shown in this view) to more easily scoop up and remove the slurry of debris from within the groove, it also may help resist the ironing phenomena of the material in the groove. In some embodiments, the lubricating fluid distribution feature 170 may act as a temporary reservoir for the lubricating fluid, and/or allow the fluid to pass completely through the rudder link 118.

FIG. 4 is a perspective view of an example embodiment of a featured rudder link 218 having a debris management feature 270 in the form of a slot, or a depression, on one surface of the featured rudder link 218, and disposed substantially parallel with the intended direction of travel of the rudder link. The debris management feature 270 may also function as debris redistribution feature allowing debris to pass from the forward to the rearward edge of the rudder link. It may also function as a lubricating fluid distribution feature to distribute lubricating fluid to the bottom of the groove. The debris management feature 270 may be formed into the rudder link via coining or machining, for example. In this and in other embodiments, it may be preferable that the coined feature be disposed on a side of a chain saw that is in proximity of a source of lubrication such as an oil pump or reservoir.

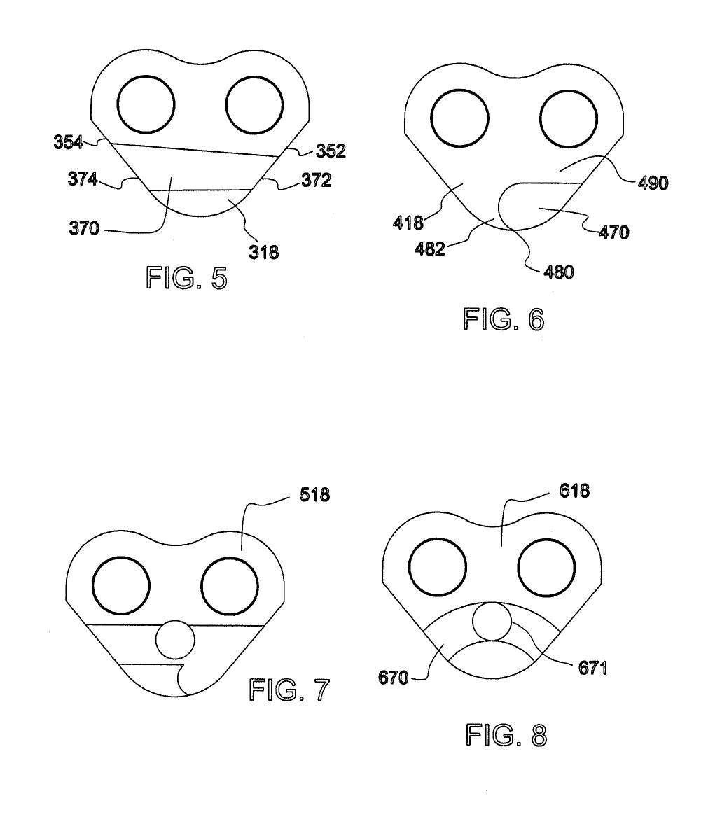

FIG. 5 is a side view of a featured rudder link 318 in accordance with various embodiments of the invention wherein a feature 370 may be a slot that has a smaller opening 372 on a leading edge 352 of the rudder link 318 and a relatively larger opening 374 on a trailing edge 354 side of the rudder link. The feature 370 may act as a lubricating fluid distribution feature and/or a debris management feature. For example, the lubricating fluid and/or a mix of lubricating fluid and debris may tend to pass along the slot of feature 370, thereby improving the management of debris and lubrication. It may also result in the debris being moved in a more turbulent fashion, thereby making cohesion of the debris within the groove less likely. The turbulence may tend to break the surface tension of any debris within the groove. Therefore, the feature 370 may also function as a surface tension breaking feature. The feature 370 may also function as a debris redistribution feature allowing debris to pass from the leading edge 352 side of the rudder link 318 to the trailing edge 354 side. Further, in various embodiments, the slotted nature of feature 370 may allow for more material to remain towards the bottom of the featured rudder link 318, thereby providing more material for wear and stability purposes at the lower portion of the link. Various embodiments may include slots or passages of various shapes formed into a rudder link.

FIG. 6 is a side view of a rudder link 418 in accordance with various embodiments of the invention wherein a feature 470 is defined within a portion of one face of rudder link 418, which may be formed, for example, by providing a depression on a portion of a surface 490 of the drive link 418. The feature 470 may include an arcuate tip 480 that may be formed somewhat like a clean out tang 482. In some embodiments alternating rudder links may include such a tang-like form on alternating opposite sides thereof to substantially extend the width of the groove for debris clean out while providing more material and sustained stability.

FIG. 7 illustrates one embodiment wherein multiple features such as those described in FIGS. 3, 4, and 6 may be combined on a rudder link 518 to form another embodiment. It will be understood that many combinations are contemplated in accordance with various embodiments.

FIG. 8 illustrates a side view of a rudder link 618 having a feature 669 formed as an arcuate groove 670, and including a through hole 671. Lubricating fluid and/or a combination of lubricating fluid and debris may be formed into a slurry that may be picked upward from a lower portion of the groove and made more turbulent within the curved slot. Lubricating fluid may be added to the slurry via the through hole 671. Then the slurry may be dropped behind the rudder link 618 as it moves through the groove to be scooped out by a following clean out link.

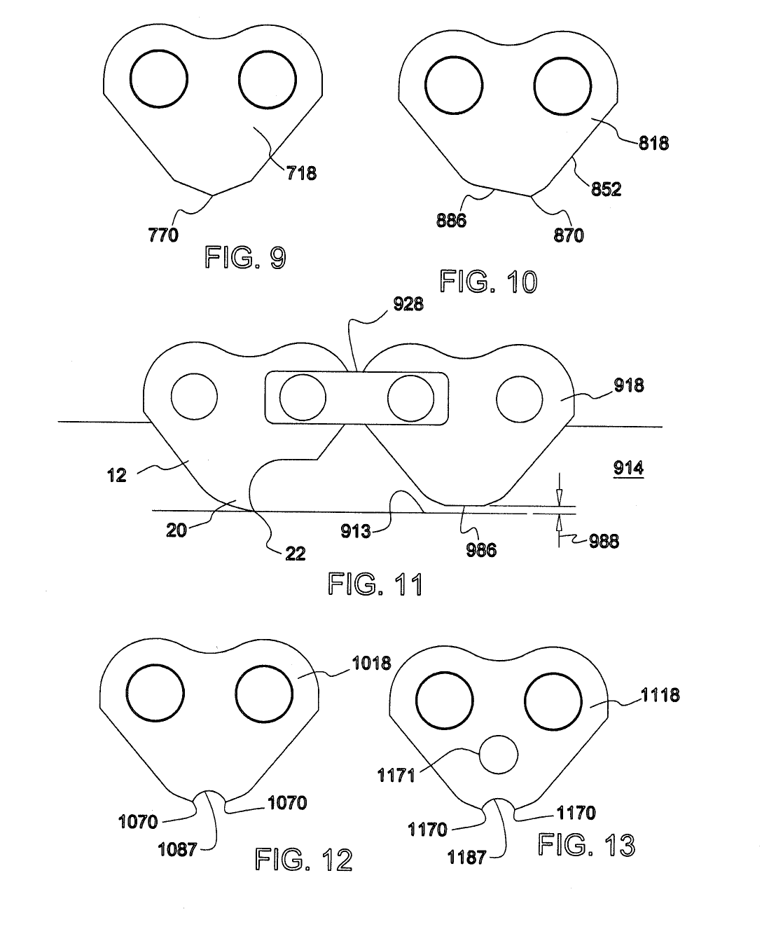

FIG. 9 is a side view illustrating various embodiments wherein a featured rudder link 718 may include mechanical contact feature such as a contact member 770 that serves to help break up debris within the groove and/or cause a more turbulent action on the debris within the groove. The contact member 770 may provide greater interference with and/or pressure on the debris, and increased turbulence to churn up the debris by causing somewhat of a turbulent boundary layer adjacent the bottom portion of the rudder link. In various embodiments, the point contact member may physically make contact with the bottom of the groove, and in other embodiments, it may not contact the bottom of the groove.

FIG. 10 is a side view illustrating various embodiments wherein a featured rudder link 818 includes a point contact member 870 substantially near a leading edge 852 thereof. A relief surface 886 may provide greater turbulence. Various other embodiments may include different relief surface angles and geometric forms other than as illustrated. The point contact member and relief surface may also be located differently.

FIG. 11 illustrates a side view of a featured rudder link 918 coupled with a clean out drive link 12 via tie straps 928 (one tie strap is hidden behind another in the figure). A height differential 988 exists in the embodiment between the bottom 986 of the rudder link 918 and a tip 22 of a clean out tang 20 that may cause the clean out tang to better engage a bottom region 913 (but not necessarily physically contact) of a groove 914 of a guide bar.

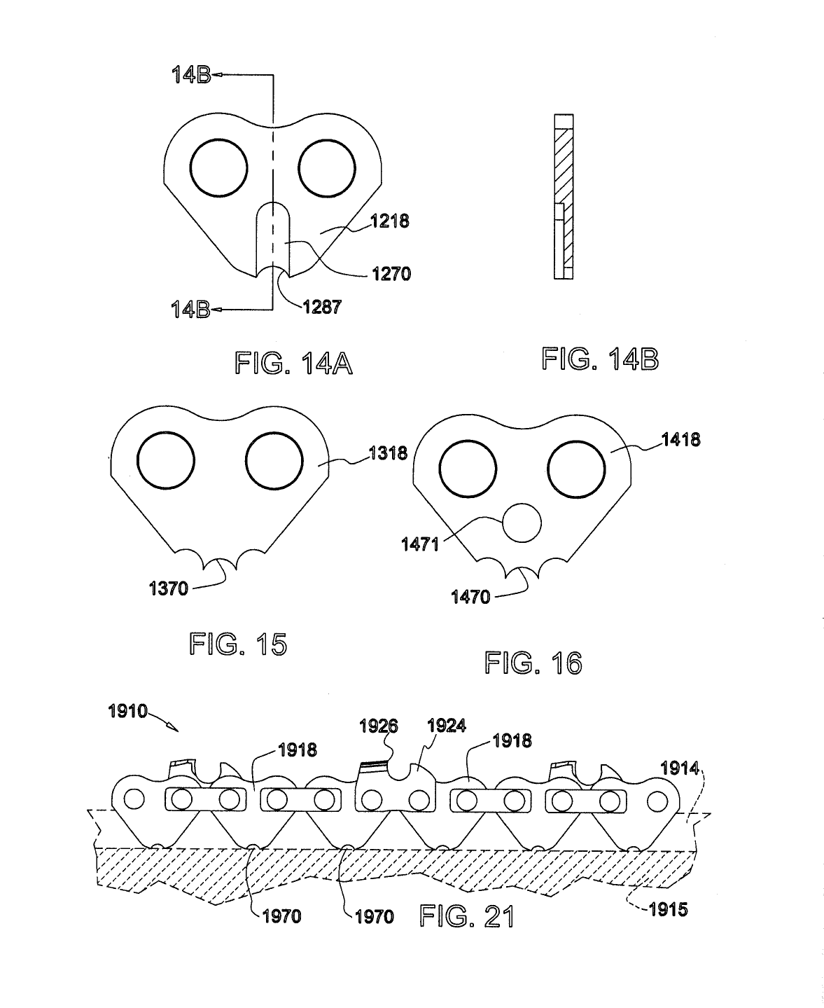

FIGS. 12 and 13 illustrate side views of respective featured rudder links 1018, 1118 in accordance with various embodiments. Each rudder link 1018, 1118 may include two point contact members 1070, 1170 on a bottom thereof. The point contacts 1070, 1170 may serve as a surface tension breaking features. An arcuate hollow 1087, 1187 is formed between the point contacts 1070, 1170 which may serve to distribute lubricating fluid and may also increase turbulence and function to break the surface tension of a layer of debris if present.

FIG. 14A is a side view and FIG. 14B is a sectional view taken through the line 14B-14B illustrating a featured rudder link 1218 in accordance with various embodiments of the invention. The rudder link 1218 may include an arcuate hollow 1287 similar to those illustrated in FIGS. 12 and 13. In addition, a vertical slot 1270 extends downwardly to the hollow 1287, which may also serve as a lubricating fluid distribution feature.

FIGS. 15 and 16 are side views illustrating featured rudder links 1318, 1418, each having a serrated bottom edge 1370, 1470 which act as contact members and may help churn, cut up or cut through debris which may be formed in the bottom of the groove. The embodiment illustrated in FIG. 16 also includes a hole 1471 which may serve to distribute a lubricating fluid toward the bottom of the groove.

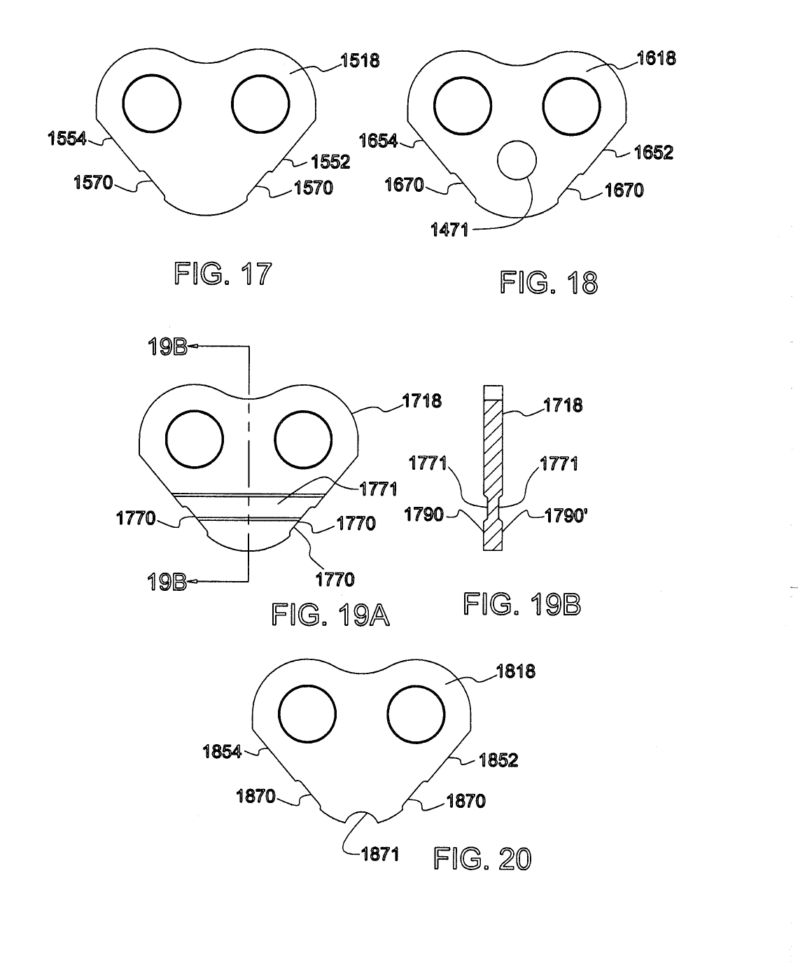

FIGS. 17 and 18 illustrate featured rudder links 1518, 1618 in accordance with various embodiments of the invention wherein the leading edges 1552, 1652 and/or the trailing edges 1554, 1654 thereof include notches 1570, 1670 formed therein. Notches 1570, 1670 may help to cause turbulent flow and to break up the surface tension of any debris which may have accumulated or may be accumulating within a groove of a guide bar. The embodiment illustrated, FIG. 18 may includes a through hole 1671 or a cavity extending partway through the rudder link 1618 to facilitate distribution of lubrication fluid.

FIG. 19A is a side view of FIG. 19B a sectional view taken of the line 19B-19B in FIG. 19A illustrating an embodiment of a featured rudder link 1718 that may have notches 1770 similar to or the same as the notches illustrated in FIGS. 17 and 18. In addition the embodiment may include slots 1771 formed into opposite sides 1790, 1790′ of the rudder link 1718.

FIG. 20 is a side view of an embodiment illustrating a featured rudder link 1818 having notches 1870 the same or similar to the notches illustrated in FIGS. 17 and 18. In addition the rudder link includes a hollow 1871 at the bottom thereof.

FIG. 21 is a side view of a section of a saw chain 1910 illustrated as it may be positioned with a groove 1914 of a guide bar 1915. A portion of the guide bar is removed for illustration purposes. The saw chain 1910 may include 100% rudder links 1918. Each of the rudder links 1918 may include a debris management feature 1970 that may be the same as, or similar to the debris management feature 1070 illustrated in FIG. 12. Other embodiments may also include saw chains with 100% rudder links having features the same as or similar to one or more of the features illustrated in FIGS. 3 though 20.

The saw chain 1910 may include cutter links 1924 each having a cutting edge 1926 on a first end and an opposite second end adapted for riding on or above a rail of the guide bar 1915. The featured rudder links may be adapted to do one or more of, distribute a lubricating fluid toward a bottom of the groove of the guide bar to mix with debris present in the groove, and/or break the surface tension of debris if present in the groove.

While a number of featured rudder link embodiments have been illustrated, several feature modifications may be used to manage debris, distribute fluid and/or break surface tension of the debris to help resist ironing or caking of the debris within the groove. Further, in addition to these benefits, the featured rudder links in accordance with embodiments of the invention provide more material towards the lower portion of the featured rudder link that is found in clean out links, which not only helps with wear and stability, it allows one to increase the number of featured rudder links that may be used in a loop, thereby improving cutting performance. Further, while embodiments have been discussed with relation to wood cutting chain, embodiments of the invention also pertain to other cutting environments such as aggregate cutting chain.

In addition to the discussion and illustrations of various embodiments above, it is to be understood, however, that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein.

1. A saw chain comprising:
a first drive link having a portion disposed below a rail on the guide bar and adapted to ride in a groove of a guide bar and having a clean out tang sized and shaped to scoop debris from within the groove, the first drive link portion having first drive link side surfaces adapted to have at least occasional contact with interior side walls of the groove; and
a second drive link coupled with the first drive link, the second drive link having a portion disposed below the rail on the guide bar and adapted to ride in the groove of the guide bar, the second drive link portion having second drive link side surfaces adapted to have at least occasional contact with the interior side walls of the groove, the second drive link side surfaces of the second drive link portions each having a greater surface area than the respective first drive link side surfaces.

2. The saw chain of claim 1 wherein the saw chain has a total number of drive links equal to a sum of a number of the first drive links and a number of the second drive links, and wherein the number of second drive links is approximately between 20 and 60 percent of the total number.

3. The saw chain of claim 2 wherein the number of second drive links is approximately 33% of the total number.

4. The saw chain of claim 1 wherein the second drive link is a featured rudder link having a feature adapted to:
distribute a lubricating fluid toward a bottom of the groove of the guide bar to mix with debris present in the groove,
break the surface tension of debris if present in the groove, and/or redistribute debris present in the groove to be scooped from the groove by one or more of the first drive links.

5. The saw chain of claim 4 wherein the saw chain has a total number of drive links equal to a sum of a number of the first drive links and a number of the second drive links, the number of second drive links is approximately 50% of the total number.

6. The saw chain of claim 1 wherein the second drive link portion includes a lubrication distribution feature adapted to distribute a lubrication fluid toward the bottom, edge, and/or side of the link comprising one or more of:
a through hole disposed through the second drive link portion;
a depression in at least one of the side surfaces of the second drive link portion; and
a slot in at least one of the side surfaces of the second drive link portion;

7. The saw chain of claim 6, wherein the slot is arranged substantially parallel with a direction of travel of the saw chain

8. The saw chain of claim 6, wherein the slot is arranged substantially perpendicular with the direction of travel of the saw chain and disposed to be substantially open proximal to the bottom of the groove

9. The saw chain of claim 1 wherein each of at least a portion of the second drive links includes a surface tension breaking feature adapted to break the surface tension of debris present in the groove.

10. The saw chain of claim 9, wherein the surface tension breaking feature includes one or more of:
a contour on a lower edge of the at least a portion of the second drive links to induce an area of increased turbulence;
a single point contact member on a bottom edge of the at least a portion of the second drive links;
notches on one or both of a leading edge and a trailing edge of the at least a portion of the second drive links;
a hollow on the bottom edge of the at least a portion of the second drive links providing two point contacts members on opposite sides of the hollow and an area of increased turbulence;
a serration on the bottom edge of the at least a portion of the second drive links; and/or
a slot in at least one of the second drive link side surfaces directed substantially parallel with a direction of travel of the saw chain having an opening on the leading edge of the at least a portion of the second drive links and a second opening on the trailing edge thereof, the first opening being smaller than the second opening.

11. The saw chain of claim 1 wherein the second drive link portion includes a debris redistribution feature adapted to help redistribute debris in the groove.

12. The saw chain of claim 11, wherein the debris redistribution feature comprises a slot in at least a portion of the second drive link side surfaces.

13. The saw chain of claim 12, wherein the slot is arranged substantially parallel with a direction of travel of the saw chain.

14. The saw chain of claim 12, wherein the slot is an arcuate slot being concave toward the bottom of the groove in at least a portion of the second drive links.

15. The saw chain of claim 1 wherein the second drive link portion includes a first depression on a first side surface thereof forming a first tang-like form on the first side surface, and
a second portion of the second drive links includes a second depression on a second side surface thereof forming a second tang-like form on the second side surface;
the first tang-like form and the second tang-like form being on alternating opposite sides of the saw chain to together substantially extend the width of the groove for debris clean out.

16. A method of forming a saw chain comprising:
providing first drive links having a portion disposed below a rail on the guide bar and adapted to ride in a groove of a guide bar and having a clean out tang sized and shaped to scoop debris from within the groove, the first drive link portions having two first drive link side surfaces on opposite sides thereof adapted to have at least occasional contact with interior side walls of the groove;
providing second drive links having a portion disposed below the rail on the guide bar and adapted to ride in the groove of the guide bar, the second drive link portions each having second drive link side surfaces adapted to have at least occasional contact with the interior side walls of the groove, the second drive link side surfaces having a greater surface area than the first drive link side surfaces.
coupling the first drive links and the second drive links

17. The method of forming a saw chain of claim 16 wherein the coupling first drive links and the coupling second drive links includes providing a number of second drive links approximately equal to between 20 and 60 percent of a sum of a number of the first drive links and the number of the second drive links.

18. The method of forming a saw chain of claim 16 wherein the coupling first drive links and the coupling second drive links includes providing two first drive links for every one second drive links.

19. The method of forming a saw chain of claim 16, wherein the providing the second drive links includes providing at least one featured second drive link.

20. The method of forming a saw chain of claim 19, wherein the providing at least one featured drive link includes one or more of:
forming a lubricating fluid distribution feature into the second drive link portion that is adapted to help distribute a lubricating fluid toward a bottom, side and/or edge of the groove of the guide bar to mix with debris in the groove;
forming a surface tension breaking feature into the second drive link portion that is adapted to help break the surface tension of any debris if present in the groove; and
forming a debris redistribution feature into the second drive link portion that is adapted to help redistribute debris in the groove to be scooped from the groove by the tang of one or more of the first drive links.

21. The method of forming a saw chain of claim 19 wherein the providing the at least one featured drive link includes providing a feature that includes a slot, hole, relief, and/or depression in one side of the featured drive link.

22. A saw chain comprising:
a cutter link having a cutting edge on a first end and an opposite second end adapted for riding on or above a rail of a guide bar; and
a featured rudder link adapted to ride in a groove of the guide bar and coupled with the cutter link.

23. The saw chain of claim 22, wherein the featured rudder has material removed such that the link is adapted to do one or more of:
distribute a lubricating fluid toward a bottom of the groove of the guide bar to mix with debris present in the groove,
redistribute debris present in the groove to be scooped from the groove by one or more of the first drive links, and/or break the surface tension of debris if present in the groove.

24. The saw chain of claim 22 wherein the saw chain includes 100% featured rudder links coupled with the cutter links.

25. The saw chain of claim 22 wherein featured rudder link include a surface tension breaking feature adapted to break the surface tension of debris present in the groove.

26. The saw chain of claim 25, wherein the surface tension breaking feature includes one or more of:
a contour on a lower edge of the at least a portion of the second drive links to induce an area of increased turbulence;
a single point contact member on a bottom edge of the at least a portion of the second drive links;
notches on one or both of a leading edge and a trailing edge of the at least a portion of the second drive links;
a hollow on the bottom edge of the at least a portion of the second drive links providing two point contacts members on opposite sides of the hollow and an area of increased turbulence;
a serration on the bottom edge of the at least a portion of the second drive links; and/or
a slot in at least one of the second drive link side surfaces directed substantially parallel with a direction of travel of the saw chain having an opening on the leading edge of the at least a portion of the second drive links and a second opening on the trailing edge thereof, the first opening being smaller than the second opening.

27. The saw chain of claim 25, wherein the surface tension breaking feature includes a hollow on the bottom edge of the at least a portion of the second drive links providing two point contacts on opposite sides of the hollow and an area of increased turbulence.
